(19) United States
(12) Patent Application Publication
(10) Pub. No.: US 2012/0314552 A1
(43) Pub. Date: Dec. 13, 2012

(54) OPTICAL DISC APPARATUS

(75) Inventor: Tomohisa MAEDA, Osaka (JP)

(73) Assignee: Funai Electric Co., Ltd.

(21) Appl. No.: 13/469,209

(22) Filed: May 11, 2012

(30) Foreign Application Priority Data
Jun. 7, 2011 (JP) 2011-127200

(51) Int. Cl. G11B 7/00

(52) U.S. Cl. 369/44.27; G9B/7

(57) ABSTRACT

An optical disc apparatus includes an optical pickup, a signal generation section which generates a control signal from an electrical signal, and a main control section which controls the optical pickup such that, during a spin-up operation of an optical disc, the optical disc is discriminated to be a multiple-layer disc with three or more layers and address information is successfully acquired from the optical disc, the optical pickup irradiates the optical disc with a light beam at a light emission power for a multiple-layer disc with three or more layers. However, if disc information is not successfully acquired, the main control section controls the optical pickup to try again to acquire the disc information at the light emission power for a multiple-layer disc with three or more layers.

This application is based on Japanese Patent Application No. 2011-127200 filed on Jun. 7, 2011, the contents of which are hereby incorporated by reference.

### BACKGROUND OF THE INVENTION

1. Field of the Invention

The present invention relates to optical disc apparatus for playback from or recording to optical discs, and more particularly relates to optical disc apparatus that allow playback from or recording to a plurality of types of optical discs.

2. Description of Related Art

Today, optical discs such as DVDs (digital versatile discs) and BDs (Blu-ray Discs, a registered trademark) are popular and widely used. For the recording and playback of information, such as audio and video information, to and from optical discs, optical disc apparatus are available. Well-known optical disc apparatus include, among others, DVD players, BD recorders, and CD-ROM drives connected to personal computers.

An optical disc apparatus is provided with an optical pickup for irradiating an optical disc with a light beam to read information. The optical pickup shines the optical beam onto the information recording surface of the optical disc, which is fixed to a turntable and is being rotated.

The light reflected from the information recording surface is received by a photodetector, for example a photodiode, provided inside the optical pickup. The photodetector converts the light into an electrical signal and, based on the thus obtained electrical signal, outputs the information recorded on the optical disc.

Accurate reading of information from the optical disc requires operation whereby the optical axis of the light beam is made to follow the center of a sequence of pits (tracking operation). For that purpose, the optical pickup incorporates an actuator for driving an objective lens in the radial direction of the optical disc and a tracking servo for controlling the actuator.

With a single optical pickup, however, it is not possible to playback from or record to all types of optical discs. Modern optical disc apparatus are therefore provided with a plurality of optical pickups and switch among them to suit the detected type of optical disc.

As optical disc apparatus that switch among a plurality of optical pickups, there have been disclosed and proposed those which adjust the power of the emitted light beam according to the result of discrimination of the disc type and those that irradiate a predetermined area with a light beam to detect a BCA (burst cutting area) and thereby check the number of layers (see, for example, JP-A-2007-265596 and JP-A-2009-116990).

However, the standards require that the read power for BDs be 0.7 mW with BD-R DL (Blu-ray Disc Recordable Double Layer) and 1.2 mW with a BDXL (Blu-ray Disc XL). When a BDXL is spun up, it is desirable that the LD emission be at 1.2 mW from the start, but consideration needs to be given also to erroneous discrimination of the disc type.

In practice, therefore, until disc information containing the disc type is read and a disc is confirmed to be a BDXL, light is emitted at 0.7 mW, not at 1.2 mW. This is because irradiating a BD-R DL with light at 1.2 mW may destroy the disc.

However, irradiating a BDXL with light at 0.7 mW may, when dust or the like diminishes the emitted power, result in insufficient power. This leads to failure to read disc information from the BDXL, causing various adjustments and failure to read disc information to be repeated, and eventually failure to spin up.

### SUMMARY OF THE INVENTION

An object of the present invention is to provide an optical disc apparatus capable of playback or recording which can efficiently execute a retry resulting from a failed read during a spin-up operation for a BDXL.

To achieve the above object, according to the present invention, an optical disc apparatus includes: an optical pickup including a light source which irradiates the recording surface of an optical disc with a light beam and a photodetector which performs photoelectric conversion on the light reflected from the recording surface; a signal generation section which generates a control signal from an electrical signal obtained by the photoelectric conversion; and a servo control section which controls the optical pickup according to the control signal. Here, the optical disc apparatus further includes: a main control section which controls the optical pickup such that, during a spin-up operation of the optical disc, as soon as the optical disc is discriminated to be a multiple-layer disc with three or more layers and in addition address information indicating a physical position on the recording surface is successfully acquired from the optical disc, the optical pickup irradiates the optical disc with a light beam at a light emission power for a multiple-layer disc with three or more layers.

To achieve the above object, in the optical disc apparatus according to the invention, the main control section controls the optical pickup such that, during the spin-up operation of the optical disc, when the optical disc is discriminated to be a multiple-layer disc with three or more layers, and the address information is successfully acquired from the optical disc, but disc information indicating the type of the optical disc is not successfully acquired, the optical pickup tries again to acquire the disc information at the light emission power for a multiple-layer disc with three or more layers.

To achieve the above object, in the optical disc apparatus according to the invention, the main control section controls the optical pickup such that, during the spin-up operation of the optical disc, as soon as the optical disc is discriminated to be a BDXL and in addition address information is successfully acquired from the optical disc, the optical pickup irradiates the optical disc with a light beam at 1.2 mW, which is a light emission power for a BDXL.

As described above, according to the present invention, when a disc that is assumed to be a BDXL is spun up, as soon as a read of address information is successful, it is confirmed to be a BDXL, and light is emitted at 1.2 mW. Thereafter, if a read of disc information is unsuccessful, a retry is made with light emitted at 1.2 mW. In this way, it is possible to reduce the likelihood of insufficient emitted power resulting in failure to read disc information and eventually failure to spin up. That is, in a spin-up operation of a multiple-layer disc with three or more layers which requires light emitted at higher power, it is possible to reduce the likelihood of failure of the spin-up operation.

### BRIEF DESCRIPTION OF THE DRAWINGS

FIG. 1 is a block diagram showing the configuration of an optical disc apparatus in one embodiment of the invention;

FIG. 2 is a diagram schematically showing the optical system of an optical pickup in one embodiment of the invention;

FIG. 3 is a flow chart showing spin-up operation in one embodiment of the invention; and

FIG. 4 is a flow chart showing conventional spin-up operation

### DETAILED DESCRIPTION OF PREFERRED EMBODIMENTS

Hereinafter, the present invention will be described by way of an embodiment with reference to the accompanying drawings. It should be understood that the embodiment described below is simply illustrative and is in no way meant to limit the invention.

### 1. Internal Configuration

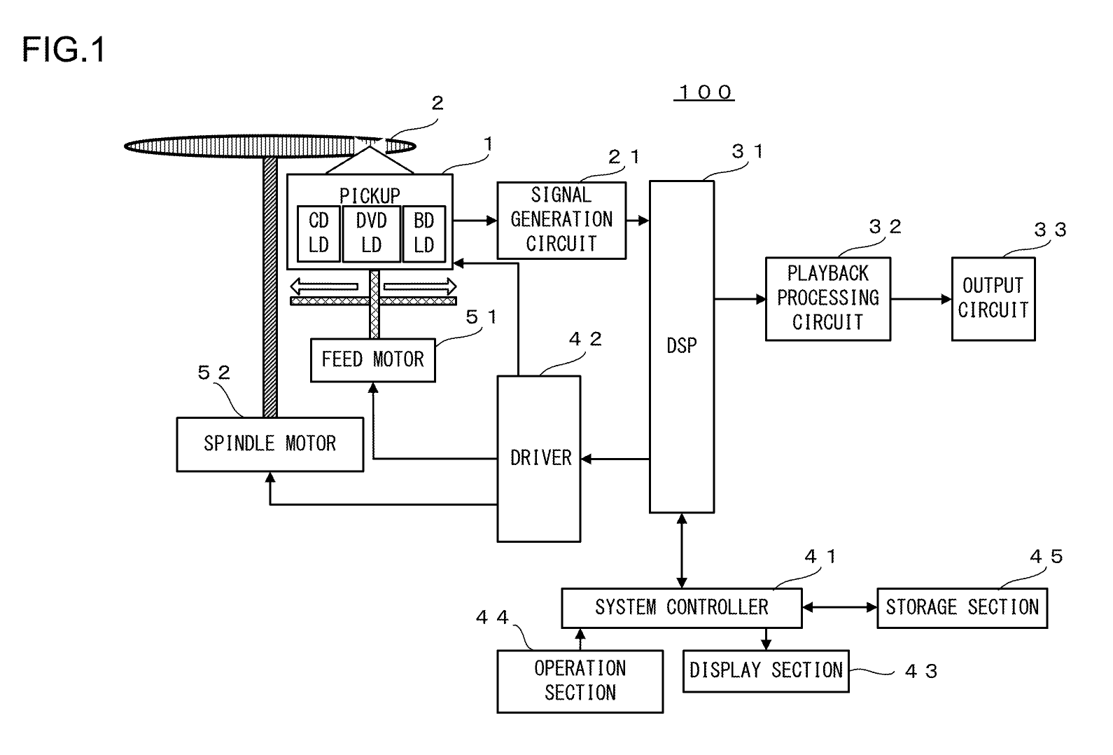

FIG. 1 is a diagram showing the configuration of a disc player 100 (as an optical disc apparatus) embodying the invention. The disc player 100 includes an optical pickup 1, a signal generation circuit 21 (as a signal generation section), a DSP (digital signal processor) 31 (as a servo control section), a playback processing circuit 32, an output circuit 33, a system controller 41 (as a main control section), a driver 42, a display section 43, an operation section 44, a storage section 45, a feed motor 51, and a spindle motor 52.

The optical pickup 1 irradiates an optical disc 2 with a light beam to read various kinds of information, such as audio information and video information, recorded on the optical disc 2. The optical pickup 1 is provided with a light beam for CDs, a light beam for DVDs, and a light beam for BDs. The configuration inside the optical pickup 1 will be described in detail later.

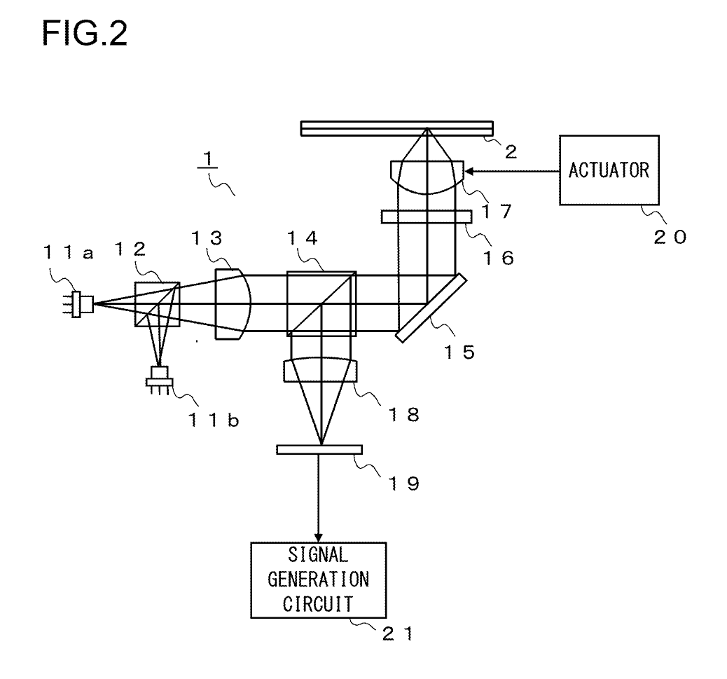

The signal generation circuit 21 performs calculation processing on the basis of the signal obtained from a photodetector 19 (see FIG. 2) provided in the optical pickup 1 to generate various signals such as an RF signal, a focus error signal, and a tracking error signal. The thus generated various signals are fed to the DSP 31.

The DSP 31 performs image processing on the basis of the RF signal fed from the signal generation circuit 21 to generate a video signal, and feeds it to the playback processing circuit 32. The playback processing circuit 32 performs D/A (digital to analog) conversion processing on the image signal for output to an unillustrated monitor. The signal obtained through the conversion processing is fed via the output circuit 33 to an external device.

The DSP 31 generates servo signals based on the focus error signal and tracking error signal fed from the signal generation circuit 21; it generates, for example, a tracking servo signal for achieving tracking servo and a focus servo signal for achieving focus servo. The generated servo signals are fed to the driver 42. Thus, the tracking control, focus control, etc. of an objective lens 17 (see FIG. 2) provided in the optical pickup 1 are achieved.

The system controller 41 controls, via the DSP 31, the operation of the optical pickup 1, the feed motor 51, the spindle motor 52, etc. The system controller 41 is realized for example, through execution of a predetermined software program on a calculation processing device such as a plurality of microprocessors.

The system controller 41, on one hand, accepts information from the operation section 44 and transfers it to the DSP 31 and, on the other hand, receives information from the DSP 31 and transfers it to the display section 43. The system controller 41 also stores information used in various calculations in the storage section 45, which is composed of a semiconductor storage device or the like.

The driver 42 controls, based on the servo signals etc. fed from the DSP 31, the driving of the optical pickup 1, the feed motor 51, and the spindle motor 52. The feed motor 51 drives the optical pickup 1 in the radial direction of the optical disc 2. The spindle motor 52 drives the optical disc 2 in its rotation direction.

### 2. Configuration of the Optical Pickup

FIG. 2 is a diagram showing an outline of the configuration of the optical system of the optical pickup 1 in one embodiment of the invention. The optical pickup 1 shines a light beam onto the optical disc 2 and receives the reflected light; it thereby reads information recorded on the recording surface of the optical disc 2.

The optical pickup 1 includes a first light source 11a, a second light source 11b, a dichroic prism 12, a collimator lens 13, a beam splitter 14, a deflecting mirror 15, a liquid crystal element 16, an objective lens 17, a detection lens 18, a photodetector 19, and an actuator 20.

The first light source 11a is a laser light source that can emit a light beam in a 650 nm band corresponding to DVDs and a light beam in a 780 nm band corresponding to CDs. The second light source 11b is a laser diode that can emit light in a 405 nm band corresponding to BDs.

Although the embodiment under discussion deals with a case where, as the first light source 11a, a two-wavelength integrated laser diode having two light-emission points is used which can emit light beams of two different wavelengths, this is not meant as any limitation; instead, it is possible to use, for example, a laser diode that emits a light beam of a single wavelength alone.

The dichroic prism 12 transmits the light beam emitted from the first light source 11a, which emits the light beam for DVDs, and reflects the light beam emitted from the second light source 11b, which emits the light beam for BDs. The dichroic prism 12 aligns the optical axes of the light beams emitted from the first and second light sources 11a and 11b with each other. The light beam thus transmitted or reflected by the dichroic prism 12 is directed to the collimator lens 13.

The collimator lens 13 converts the light beam transmitted through the dichroic prism 12 into a parallel beam. Here, a parallel beam denotes a beam of light in which the paths of all the rays of light emitted from the first and second light sources 11a and 11b are substantially parallel to the optical axis. The light beam converted into a parallel beam by the collimator lens 13 is directed to the beam splitter 14.

The beam splitter 14 functions as a light splitting element that splits the incoming light beam. The beam splitter 14, on one hand, transmits the light beam coming from the collimator lens 13 to direct it toward the optical disc 2 and, on the other hand, reflects the light reflected from the optical disc 2 to direct it toward the photodetector 19. The light beam transmitted through the beam splitter 14 is directed to the deflecting mirror 15.

The deflecting mirror 15 reflects the light beam transmitted through the beam splitter 14 to direct it to the optical disc 2. The deflecting mirror 15 is inclined at 45° with respect to the optical axis of the light beam from the beam splitter 14, and the optical axis of the light beam reflected from the deflecting mirror 15 is approximately perpendicular to the recording surface of the optical disc 2. The light beam reflected on the deflecting mirror 15 is directed to the liquid crystal element 16.

Applying a voltage across liquid crystal (not shown) held between transparent electrodes (none is shown) causes liquid crystal molecules to change their alignment direction. Exploiting this property, the liquid crystal element 16 varies the refractive index of the liquid crystal and thereby controls the phase of the light beam transmitted through it.

Disposing the liquid crystal element 16 makes it possible to correct the spherical aberration arising from variation in the thickness of the resin layer protecting the recording surface of the optical disc 2. The light beam transmitted through the liquid crystal element 16 is directed to the objective lens 17.

The objective lens 17 makes the light beam transmitted through the liquid crystal element 16 converge on the recording surface of the optical disc 2. The objective lens 17 is movable by the actuator 20, which will be described later, for example, in the up-down direction and in the left-right direction in FIG. 2, and its position is controlled according to the focus servo signal and tracking servo signal.

The light reflected from the optical disc 2 passes through the objective lens 17 and then through the liquid crystal element 16, is then reflected on the deflecting mirror 15, is then reflected again on the beam splitter 14, and is then made to converge by the detection lens 18 on the photosensor provided on the photodetector 19.

The photodetector 19 converts the light received by the photosensor, such as a photodiode, into an electrical signal, and feeds it to the signal generation circuit 21. The photodetector 19 has a photosensitive area divided into, for example, four regions, and can, for each region individually, perform photoelectric conversion and output an electrical signal.

The actuator 20 moves the objective lens 17 in the radial direction of the optical disc 2 according to an objective lens drive signal generated by and fed from the driver 42. The actuator 20 here may be, but is not limited to, one that drives the objective lens 17 with a Lorentz force by passing a drive electric current across a coil (not shown) placed in the magnetic field formed by a permanent magnet (not shown).

The actuator 20 thus achieves tracking, in which it moves the objective lens 17 in a direction along the recording surface of the optical disc 2; in addition, the actuator 20 also achieves tilting, in which it inclines the objective lens 17 so as to swing the optical axis of the light beam directed from the objective lens 17, and focusing, in which it moves the objective lens 17 closer to or away from the optical disc 2.

### 3. Spin-Up Operation

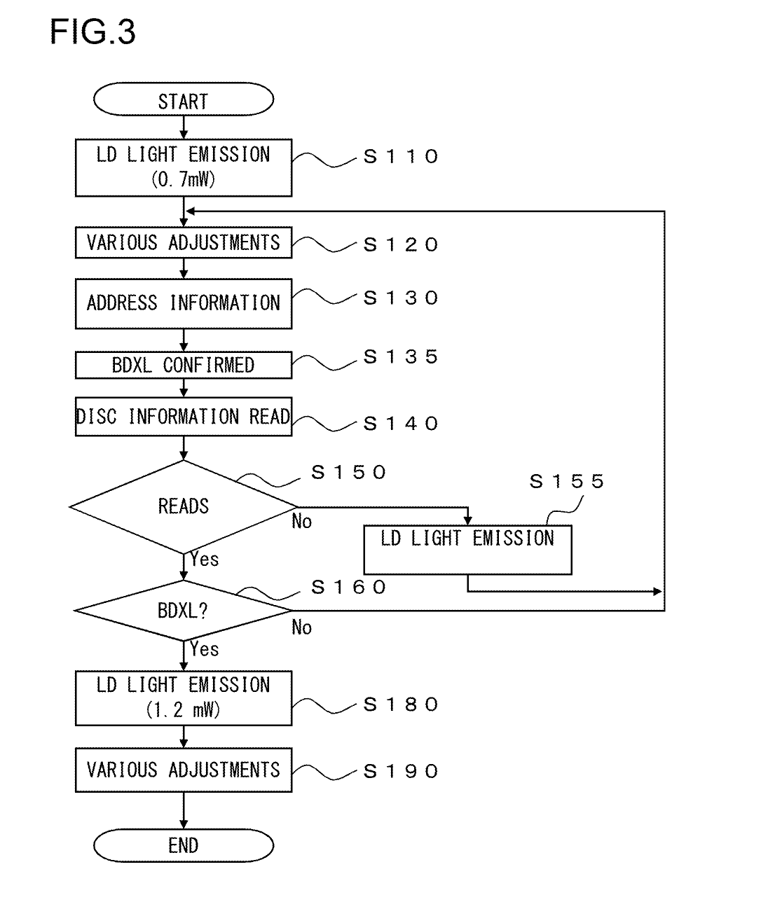

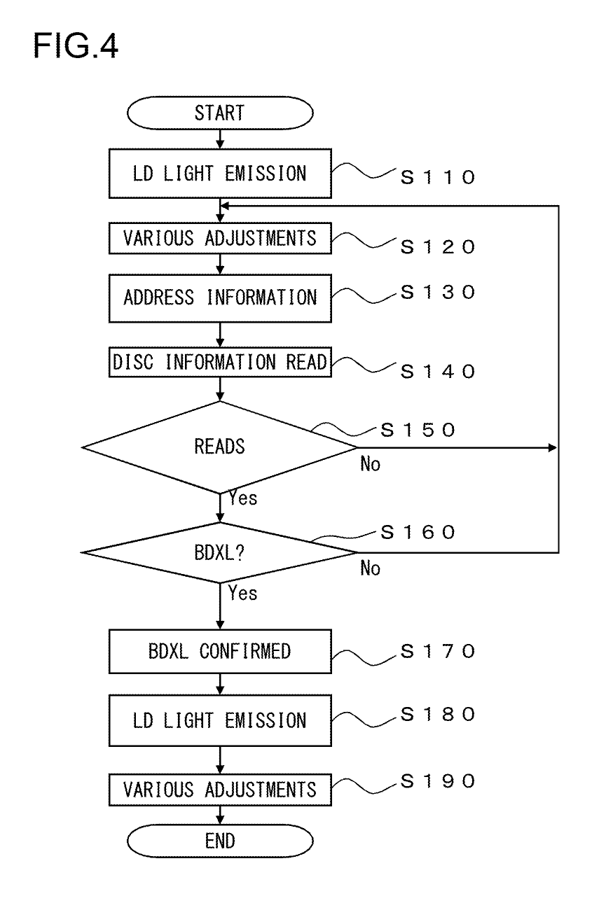

Next, the spin-up operation in one embodiment of the invention will be described with reference to flow charts in FIGS. 3 and 4. FIG. 3 is a flow chart showing the spin-up operation according to the invention, and FIG. 4 is a flow chart showing the conventional spin-up operation. Between the two flow charts, the same steps are identified by the same step numbers, and no overlapping description will be repeated.

First, the conventional spin-up operation will be described. The flow of operation shown in FIG. 4 is started when, for example during the mounting operation or playback operation of the optical disc 2, the type of the optical disc 2 is assumed to be BDXL. The assumption is made, for example, by referring to the results of S-curve balance adjustment of the focus error signal (adjustment for minimizing the focus error balance), based on the number of S-curves detected.

Accordingly, at the start of the flow, no disc information indicating the disc type has yet been read from the recording region of the optical disc 2, and therefore, although the disc type is assumed to be BDXL, it has not yet been confirmed to be so.

When the flow starts, at step S110, the system controller 41 controls the optical pickup 1 to irradiate the optical disc 2 with a light beam for BD-R DL media, that is, a 0.7 W light beam.

Next, at step S120, the system controller 41 performs various adjustments with the light beam for BD-R DL media, for example focus adjustment using the focus error signal and tracking adjustment using the tracking error signal, among others.

Next, at step S130, the system controller 41 executes a read of address information with respect to the optical disc 2. The address information here is position information indicating physical locations on the recording surface of the optical disc 2. Then, at step S140, the system controller 41 executes a read of disc information with respect to the optical disc 2. The disc information includes information indicating the disc type of the optical disc 2.

Next, at step S150, the system controller 41 checks whether or not the read of the disc information has been successful. If unsuccessful, the flow returns to step S120; if successful, then, at step S160, the system controller 41 checks whether or not the disc type indicated by the disc information is BDXL.

If the indicated disc type is not BDXL, the flow returns to step S120; if it is BDXL, then, at step S170, the system controller 41 confirms the disc type of the optical disc 2 to be BDXL.

Next, at step S180, the system controller 41 controls the optical pickup 1 to irradiate the optical disc 2 with a light beam for BDXL media, that is a 1.2 mW light beam.

Next, at step S190, the system controller 41 performs various adjustments with the light beam for BDXL media. The contents of the various adjustments here are similar to those at step S120, and therefore no overlapping description will be repeated.

In the flow of operation described above, until a disc is confirmed to be a BDXL based on the disc information read, light is emitted at 0.7 mW, not at 1.2 mW. This is because irradiating a BD-R DL with light at 1.2 mW may destroy the disc.

However, for example, when the emitted power is diminished for some cause such as dust attached to the optical disc 2, light emitted at 0.7 mW may have insufficient power, leading to failure to read disc information from the BDXL (step S140). Inconveniently, this causes various adjustments and failure to read disc information to be repeated (steps S120 through 150), and eventually failure to spin up.

Next, the spin-up operation according to the invention will be described with reference to FIG. 3. The flow of operation shown in FIG. 3, like that shown in FIG. 4, is started when, for example during the mounting operation or playback operation of the optical disc 2, the type of the optical disc 2 is assumed to be BDXL.

Steps S110 through S130 are similar to those in FIG. 4, and therefore no overlapping description will be repeated. After the execution of step S130, at step S135, the system controller 41 confirms the disc type of the optical disc 2 to be BDXL. Then, at step S140, the system controller 41 executes a read of disc information with respect to the optical disc 2. Thus, a disc is confirmed to be a BDXL before a read of disc information.

Next, at step S150, the system controller 41 checks whether or not the reads of address information and disc information have been successful. If unsuccessful, then, at step S155, the system controller 41 controls the optical pickup 1 to irradiate the optical disc 2 with a light beam for BDXL media, that is, a 1.2 mW beam, and then the flow returns to step S120.

Then, in the succeeding steps S120 through S140, read operations using the 1.2 mW beam are executed. If, in the operation loop from steps S120 through S155, step S155 is executed more than a predetermined number (for example, three to five) of times, preferably, it is recognized as failure to spin up, and the flow is ended; alternatively, the disc type may be confirmed to be BDXL, in which case the flow then returns to step S190.

If, at step S150, the reads of address information and disc information have been successful, then the system controller 41 executes the operations at steps S160, S180, and S190.

In this flow, no step corresponding to step S170 (confirmation of the disc type) included in the flow of operation in FIG. 4 is executed here, because one has already been executed at S135. If, at steps S155 and S120, the light beam for BDXL media has already been emitted and the various adjustments for BDXL media have already been performed, the operations at steps S180 and S190 may be omitted.

In the embodiment described above, during a spin-up operation for a BDXL, as soon as a read of address information is successful, a disc is confirmed to be a BDXL, and light is emitted at 1.2 mW. Thereafter, if a read of disc information is unsuccessful, a retry is made with light emitted at 1.2 mW. In this way, it is possible to reduce the likelihood of insufficient emitted power resulting in failure to read disc information and eventually failure to spin up.

### Modifications and Variations

It should be understood that the preferred embodiments and examples by way of which the present invention has been described hereinbefore are in no way meant to limit how the invention is to be carried out; the invention allows for many modifications and variations made within the scope of spirit of its technical idea.

Thus, the invention may also be implemented as follows.

(A) Although the embodiment described above deals with a case where the functions related to the spin-up operation according to the invention are realized through execution of a software program on a calculation processing device such as a microprocessor, those functions may instead be realized by a plurality of circuits.

(B) Although the embodiment described above deals with a disc player 100 as an optical disc apparatus that executes a spin-up operation according to the invention, the invention may be applied to any other optical disc apparatus; for example, it may be applied to BD recorders for recording to optical discs.

What is claimed is:

1. An optical disc apparatus, comprising:
an optical pickup including
a light source which irradiates a recording surface of an optical disc with a light beam and
a photodetector which performs photoelectric conversion on light reflected from the recording surface;
a signal generation section which generates a control signal from an electrical signal obtained by the photoelectric conversion; and
a servo control section which controls the optical pickup according to the control signal, wherein
the optical disc apparatus further comprises:
a main control section which controls the optical pickup such that, during a spin-up operation of the optical disc, as soon as the optical disc is discriminated to be a multiple-layer disc with three or more layers and in addition address information indicating a physical position on the recording surface is successfully acquired from the optical disc, the optical pickup irradiates the optical disc with a light beam at a light emission power for a multiple-layer disc with three or more layers.

2. The optical disc apparatus according to claim 1, wherein
the main control section controls the optical pickup such that, during the spin-up operation of the optical disc, when the optical disc is discriminated to be a multiple-layer disc with three or more layers, and the address information is successfully acquired from the optical disc, but disc information indicating a type of the optical disc is not successfully acquired, the optical pickup tries again to acquire the disc information at the light emission power for a multiple-layer disc with three or more layers.

3. The optical disc apparatus according to claim 2, wherein
the main control section controls the optical pickup such that, during the spin-up operation of the optical disc, as soon as the optical disc is discriminated to be a BDXL (Blu-ray Disc XL) and in addition address information is successfully acquired from the optical disc, the optical pickup irradiates the optical disc with a light beam at 1.2 mW, which is a light emission power for a BDXL.
